(19) United States
(12) Patent Application Publication
(10) Pub. No.: US 2017/0121032 A1
(43) Pub. Date: May 4, 2017

(54) EXHAUST INFRARED SIGNATURE REDUCTION ARRANGEMENT AND METHOD OF REDUCING TEMPERATURE OF AT LEAST A PORTION OF AN EXHAUST DUCT

(71) Applicant: Sikorsky Aircraft Corporation, Stratford, CT (US)

(72) Inventors: Joseph Pantalone, III, Guilford, CT (US); John S. Chapkovich, III, Derby, CT (US)

(21) Appl. No.: 15/251,401

(22) Filed: Aug. 30, 2016

Related U.S. Application Data
(60) Provisional application No. 62/248,512, filed on Oct. 30, 2015.

(51) Int. Cl. B64D 33/04

(52) U.S. Cl. CPC B64D 33/04; B64D 2033/045

(57) ABSTRACT

An exhaust infrared signature reduction arrangement includes an exhaust duct having a plurality of holes through a wall of the exhaust duct, and a housing surrounding at least a portion of the exhaust duct defining a cavity between the exhaust duct and the housing.

### CROSS REFERENCE TO RELATED APPLICATIONS

This application claims the benefit of U.S. Provisional Application Ser. No. 62/248,512, filed Oct. 30, 2015, the entire disclosure of which is incorporated herein by reference.

### STATEMENT OF FEDERAL SUPPORT

This invention was made with Government support under W911W6-13-P-0010 awarded by United States Army. The Government has certain rights in the invention.

### BACKGROUND

Exhaust ducts on vehicles can create infrared signatures that may be detectable by imaging equipment configured to image objects in the infrared wavelengths. Such signatures can be used to target the vehicles. Devices and methods to alter the infrared signatures of a vehicle are of interest to those concerned with such matters.

### BRIEF DESCRIPTION

Disclosed herein is an exhaust infrared signature reduction arrangement. The arrangement includes an exhaust duct having a plurality of holes through a wall of the exhaust duct, and a housing surrounding at least a portion of the exhaust duct defining a cavity between the exhaust duct and the housing.

In addition to one or more of the features described above, or as an alternative, further embodiments include the housing having an opening configured for fluid to flow through and into the cavity.

In addition to one or more of the features described above, or as an alternative, further embodiments include the plurality of holes are positioned at locations to decrease temperatures of at least a portion of the exhaust duct known to exhibit high temperatures during operation of a vehicle employing the exhaust infrared signature reduction arrangement.

In addition to one or more of the features described above, or as an alternative, further embodiments include the plurality of holes are positioned in an area exposed to line-of-sight from outside of a vehicle employing the exhaust infrared signature reduction arrangement.

In addition to one or more of the features described above, or as an alternative, further embodiments include a plurality of the plurality of holes are positioned on a portion of the wall that crosses a straight line flow direction of exhaust gases.

In addition to one or more of the features described above, or as an alternative, further embodiments include a conical body having a conical shape.

In addition to one or more of the features described above, or as an alternative, further embodiments include at least one fin configured to redirect exhaust gases away from the wall.

In addition to one or more of the features described above, or as an alternative, further embodiments include the at least one fin is attached to the wall.

In addition to one or more of the features described above, or as an alternative, further embodiments include an insulation member is positioned between the at least one fin and the wall.

In addition to one or more of the features described above, or as an alternative, further embodiments include at least one seal sealingly engaged with the exhaust duct and the housing.

Further disclosed herein is a method of reducing temperature of at least a portion of an exhaust duct. The method includes flowing fluid into a cavity defined between a wall of the exhaust duct and a housing positioned radially outward of the exhaust duct, and flowing fluid out of the cavity through a plurality of holes in the wall.

In addition to one or more of the features described above, or as an alternative, further embodiments include redirecting exhaust gases away from the wall.

In addition to one or more of the features described above, or as an alternative, further embodiments include redirecting exhaust gases away from the at least one portion.

In addition to one or more of the features described above, or as an alternative, further embodiments include attaching redirecting fins to the wall by attaching redirecting fins to an insulating member which is attached to the wall.

In addition to one or more of the features described above, or as an alternative, further embodiments include urging exhaust gases radially inwardly away from the wall.

Further disclosed herein is an aircraft that includes, an engine, an exhaust duct in operable communication with the engine and any of the exhaust infrared signature reduction arrangements discussed above.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 depicts a partial perspective view of an exhaust infrared signature reduction arrangement disclosed herein with a portion of a housing removed;

FIG. 2 depicts an alternate perspective view of the exhaust infrared signature reduction arrangement of FIG. 1;

FIG. 3 depicts a partial schematic cross sectional view of the exhaust infrared signature reduction arrangement of FIG. 1;

FIG. 4 depicts a partial exploded view of the exhaust infrared signature reduction arrangement of FIG. 1; and

FIG. 5 depicts a vehicle employing the exhaust infrared signature reduction arrangement of FIG. 1.

### DETAILED DESCRIPTION

A detailed description of one or more embodiments of the disclosed apparatus and method are presented herein by way of exemplification and not limitation with reference to the Figures.

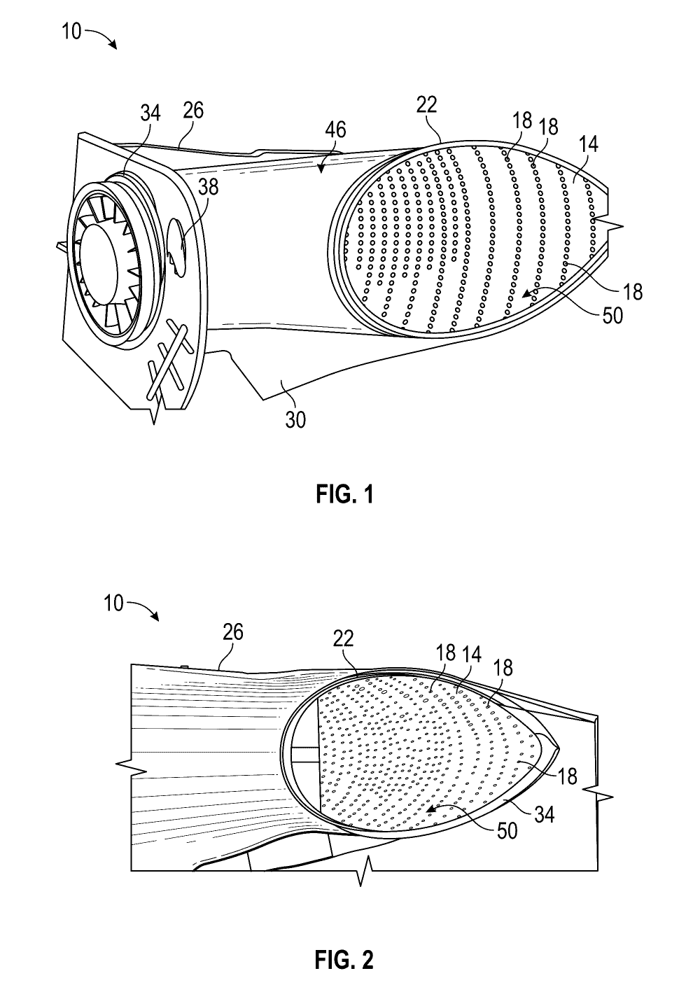

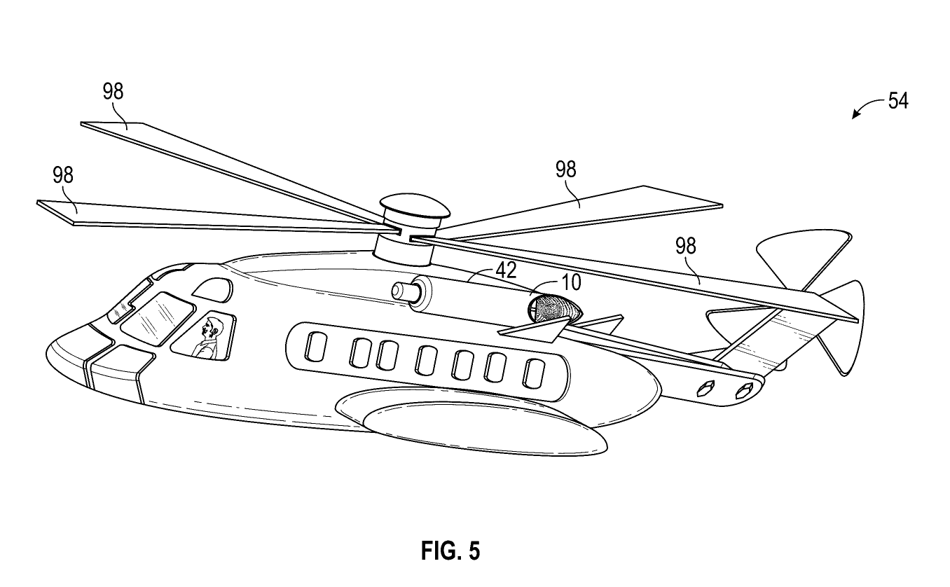

Referring to FIGS. 1-2, an exhaust infrared signature reduction arrangement 10 is illustrated. The arrangement 10 includes an exhaust duct 14 having a plurality of holes 18 through a wall 22 of the exhaust duct 14. A housing 26 surrounds at least a portion of the exhaust duct 14 and defines a cavity 30 between the exhaust duct 14 and the housing 26. Optional seals 34 are sealingly engaged with both the exhaust duct 14 and the housing 26. An opening 38 in the housing 26 allows fluid to flow therethrough and into the cavity 30, while the holes 18 allow the same fluid to flow out of the cavity 30. The fluid flowing into the cavity may be RAM air or IPS (Inlet Particle Separator) air. Regardless, the fluid is typically much cooler than exhaust gases being exhausted from an engine 42 (FIG. 5). As such, the fluid cools the exhaust duct 14 as it flows along a surface 46 (FIG. 1) on the outside of the wall 22 (within the cavity 30) and as it flows out of the cavity 30 through the holes 18, and as it flows along an inside surface 50 of the wall 22. This cooling of the wall 22 alters an infrared signature of the exhaust duct 14 in a way that makes it harder to track or target, by infrared imaging equipment, for example, since the exhaust duct's 14 temperature with the cooling deviates less from temperatures of things around the exhaust duct 14.

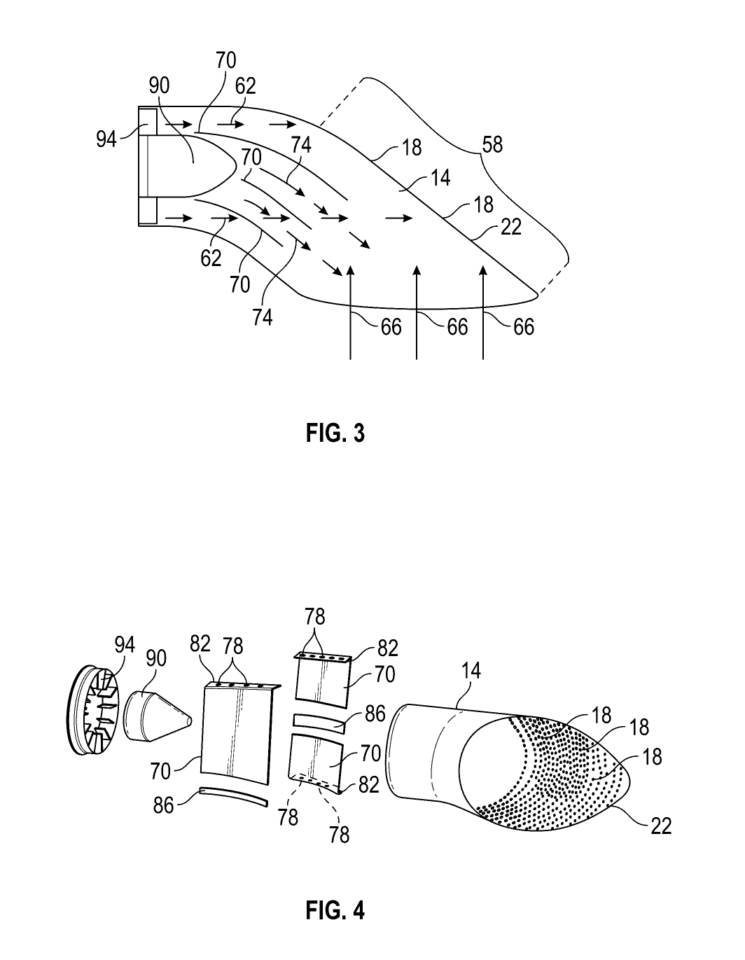

The holes 18 are positioned at locations of the wall 22 to decrease temperatures of areas that are known to exhibit high temperatures during operation of a vehicle 54 (FIG. 5) employing the exhaust infrared signature reduction arrangement 10. In FIG. 3, for example, a plurality of the plurality of holes 18 are positioned on a portion 58 of the wall 22 that crosses a straight line flow direction of exhaust gases identified by arrows 62. Cooling of the portion 58 is also helpful since the portion 58 is exposed via line-of-sight along arrows 66, for example, from outside of the vehicle 54 employing the exhaust infrared signature reduction arrangement 10.

FIG. 3 and FIG. 4 both show some additional features of the exhaust infrared signature reduction arrangement 10 that further reduce an infrared signature of the exhaust duct 14. At least one fin 70, with three of the fins 70 being illustrated, are angled or curved and attached within the exhaust duct 14 to redirect exhaust gases away from the wall 22. By redirecting some of the exhaust gases from the direction of arrows 62 to the direction of arrows 74, less of the hot exhaust gases impinge upon the portion 58 helping to reduce temperature of the wall 22 and reduce the infrared signature of the duct 14. The fins 70 can be attached directly to the wall 22 by fasteners 78 through a flange 82, for example, or by welding or brazing directly. Alternatively or in combination with the flanges 82, the fins 70 can be attached to insulation members 86 that are attached to the wall 22. The insulation members 86 can be used to reduce heat transfer from the fins 70 to the exhaust duct 14. A conical body 90 positioned central to an inlet 94 of the exhaust duct 14 can also aid in decreasing impingement of exhaust gases against the wall 22. The inlet 94 is annularly spaced between the conical body 90 and the exhaust duct 14. The cone shape of the conical body 90 can urge some of the exhaust gases radially inwardly away from the wall 22 as the exhaust gases flow past the conical body 90. Less impingement of the gases against the wall 22 can help reduce an infrared signature of the exhaust duct 14.

Referring to FIG. 5, the vehicle 54 is shown with the engine 42 and the exhaust infrared signature reduction arrangement 10 employed thereon. Although the illustrated vehicle 54 is an aircraft with rotary wings 98, alternate vehicles such as fixed wing aircraft or even ground based vehicles could also employ the exhaust infrared signature reduction arrangement 10 disclosed herein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. An exhaust infrared signature reduction arrangement, comprising:
an exhaust duct having a plurality of holes through a wall of the exhaust duct; and
a housing surrounding at least a portion of the exhaust duct defining a cavity between the exhaust duct and the housing.

2. The exhaust infrared signature reduction arrangement of claim 1, wherein the housing includes an opening configured for fluid to flow through and into the cavity.

3. The exhaust infrared signature reduction arrangement of any of claims 1-2, wherein the plurality of holes are positioned at locations to decrease temperatures of at least a portion of the exhaust duct known to exhibit high temperatures during operation of a vehicle employing the exhaust infrared signature reduction arrangement.

4. The exhaust infrared signature reduction arrangement of any of claims 1-3, wherein the plurality of holes are positioned in an area exposed to line-of-sight from outside of a vehicle employing the exhaust infrared signature reduction arrangement.

5. The exhaust infrared signature reduction arrangement of any of claims 1-4, wherein a plurality of the plurality of holes are positioned on a portion of the wall that crosses a straight line flow direction of exhaust gases.

6. The exhaust infrared signature reduction arrangement of any of claims 1-5, further comprising a conical body having a conical shape.

7. The exhaust infrared signature reduction arrangement of any of claims 1-6, further comprising at least one fin configured to redirect exhaust gases away from the wall.

8. The exhaust infrared signature reduction arrangement of claim 7, wherein the at least one fin is attached to the wall.

9. The exhaust infrared signature reduction arrangement of any of claims 7-8, wherein an insulation member is positioned between the at least one fin and the wall.

10. The exhaust infrared signature reduction arrangement of any of claims 1-9, further comprising at least one seals sealingly engaged with the exhaust duct and the housing.

11. A method of reducing temperature of at least a portion of an exhaust duct, comprising:
flowing fluid into a cavity defined between a wall of the exhaust duct and a housing positioned radially outward of the exhaust duct; and
flowing fluid out of the cavity through a plurality of holes in the wall.

12. The method of claim 11, further comprising redirecting exhaust gases away from the wall.

13. The method of any of claims 11-12, further comprising redirecting exhaust gases away from the at least one portion.

14. The method of any of claims 11-13, further comprising attaching redirecting fins to the wall by attaching redirecting fins to an insulating member which is attached to the wall.

15. The method of any of claims 11-14, further comprising urging exhaust gases radially inwardly away from the wall.

16. An aircraft, comprising:
an engine;
an exhaust duct in operable communication with the engine; and
an exhaust infrared signature reduction arrangement of any of claims 1-10.
